(19) United States
(12) Patent Application Publication
(10) Pub. No.: US 2007/0120937 A1
(43) Pub. Date: May 31, 2007

(54) System and method for hand-held printing

(75) Inventors: Adam Jude Ahne, Lexington, KY (US); Edmund Hulin James III, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/290,875

(22) Filed: Nov. 30, 2005

(51) Int. Cl. B41J 3/36

(52) U.S. Cl. 347/109

(57) ABSTRACT

System and method for hand-held printing. The method can include detecting a direction of initial movement of the hand-held printer. The method can include establishing a mode of operation including either a left-justified mode when the direction of initial movement is left to right or a right-justified mode when the direction of initial movement is right to left. The method can include maintaining the mode of operation for an entire print job.

### BACKGROUND OF THE INVENTION

Electronic images can be stored in a number of different formats. The most common formats for storing images today are the Joint Photographic Experts Group (“JPEG”) standard or bit-maps. Bit-maps include a set of data (one-bit for monochrome to multiple bytes for true color) for each pixel (or dot) of an image. A bit-map image in XGA format (1024×768 pixels) using 64 k colors (two bytes) would require nearly 1.6 million bytes of storage. JPEGs use compression techniques to reduce the storage needed with minimal loss of detail. Typically JPEGs reduce the storage necessary by a ratio of 10:1 or 20:1 (greater compression can be achieved with further losses of detail).

Ink-jet printers have large numbers of ink-jets which deposit drops of ink on a medium. The drops are very small and different colored drops can be combined to achieve true color printing. A typical print head can have 300 to 600 ink-jets. For ink-jet printers, a print swath is data that indicates when each ink-jet is to deposit a drop of ink on the media for a single pass of the print head over the media. Host-based printers rely on the host (typically a computer) to provide the printer with print swaths for each pass of the print head over the media. Host-based printers typically require a connection between the host and the printer to transfer the print swaths to the printer.

Other types of printers may have the ability to access different format data images (e.g., JPEG) and convert the data into the required print swaths. Digital photo printers would be an example of this type of printer. A digital camera takes a picture and stores the image on a memory card in JPEG format. The memory card can be removed from the camera and inserted into a digital photo printer. The printer can read the JPEG image on the memory card and convert the JPEG image to print swaths and print the image. These types of printers require significant processing power in order to convert the stored image into the print swaths required for printing.

### SUMMARY OF THE INVENTION

In one embodiment, the invention provides a method of printing with a hand-held printer. The method can include detecting a direction of initial movement of the hand-held printer. The method can include establishing a mode of operation including either a left-justified mode when the direction of initial movement is left to right or a right-justified mode when the direction of initial movement is right to left. The method can include maintaining the mode of operation for substantially an entire print job.

Some embodiments of the invention provide a hand-held printing system including a memory, a printhead connected to the memory, and a microcontroller connected to the memory and the printhead. The microcontroller can determine a horizontal direction of movement. The microcontroller can either reverse a print swath in the memory or print a print swath in reverse order when the horizontal direction of movement is determined to be a right to left direction.

Other aspects of the invention will become apparent by consideration of the detailed description and accompanying drawings.

### BRIEF DESCRIPTION OF THE DRAWINGS

FIG. 1 is a top view of a hand-held printer printing left to right according to one embodiment of the invention.

FIG. 2 is a top view of a hand-held printer printing right to left according to one embodiment of the invention.

FIG. 3 is a perspective view of a hand-held printer according to one embodiment of the invention in an open position.

FIG. 4 is a schematic illustration of architecture of a hand-held printer according to one embodiment of the invention.

FIGS. 5A and 5B are illustrations of signals from a mouse encoder indicating a direction and a distance traveled.

FIG. 6 is an illustration of a print swath.

FIG. 7 is an illustration of a printed icon for a hand-held printer printing in a right to left direction according to one embodiment of the invention.

FIGS. 8A and 8B are illustrations of print swaths compensating for printing in a right to left direction according to one embodiment of the invention.

FIGS. 9A, 9B, and 9C are a flow chart of the operation of a hand-held printer according to one embodiment of the invention.

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings, and can include electrical connections or couplings, whether direct or indirect.

In addition, it should be understood that embodiments of the invention include both hardware and software components or modules. As such, it should be noted that a plurality of hardware and software based devices, as well as a plurality of different structural components may be utilized to implement the invention. Furthermore, and as described in subsequent paragraphs, the specific configurations illustrated in the drawings are intended to exemplify embodiments of the invention and that other alternative configurations are possible.

Embodiments of the invention relate to systems and methods for operating a hand-held printer. The hand-held printer can print icons (i.e., images or text) that can be stored on a removable memory card. In some embodiments, the icons can range in size from ½″ by ½″ to ½″ by 12″. Images of the icons can be displayed on the hand-held printer to enable a user to select which icon to print. To reduce the processing power necessary in the hand-held printer, the icons can be stored on the memory card in a format that can be used by the hand-held printer with substantially no modification to the data. Printing can be performed by moving the hand-held printer in a left to right direction. This can enable the printed icons to be easily left-justified. However, in some conventional systems, printing the icons with a left to right motion can make it difficult to accurately right-justify the icons. Embodiments of the invention relate to a hand-held printer capable of printing in a left to right direction and a right to left direction.

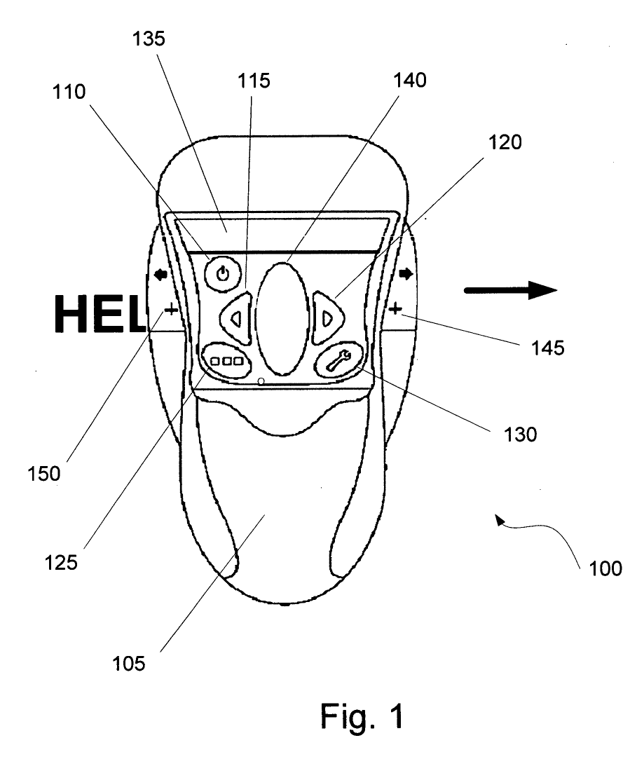

FIG. 1 illustrates one embodiment of a hand-held printer 100. A main body 105 of the hand-held printer 100 can be formed to fit in the palm of a user's hand and can resemble a standard computer mouse in size and shape, in one embodiment. The hand-held printer 100 can have a number of buttons for operating the hand-held printer. An on/off button 110 can be included on the hand-held printer 100. A scroll left button 115 and a scroll right button 120 can be included on the hand-held printer 100. A repeat button 125 and a maintenance button 130 can also be included on the hand-held printer 100. A print button 135 can be included on the hand-held printer 100, and in some embodiments, can be positioned across substantially the entire top of the hand-held printer 100.

In some embodiments of the hand-held printer 100, the hand-held printer 100 can include a display 140. In one embodiment, the display 140 can be a monochrome liquid crystal display (“LCD”) and can be 32.7 mm by 26.1 mm and can have a resolution of 101 pixels by 81 pixels. Other embodiments of the hand-held printer 100 can have other types of displays including color displays and displays of different sizes and resolutions.

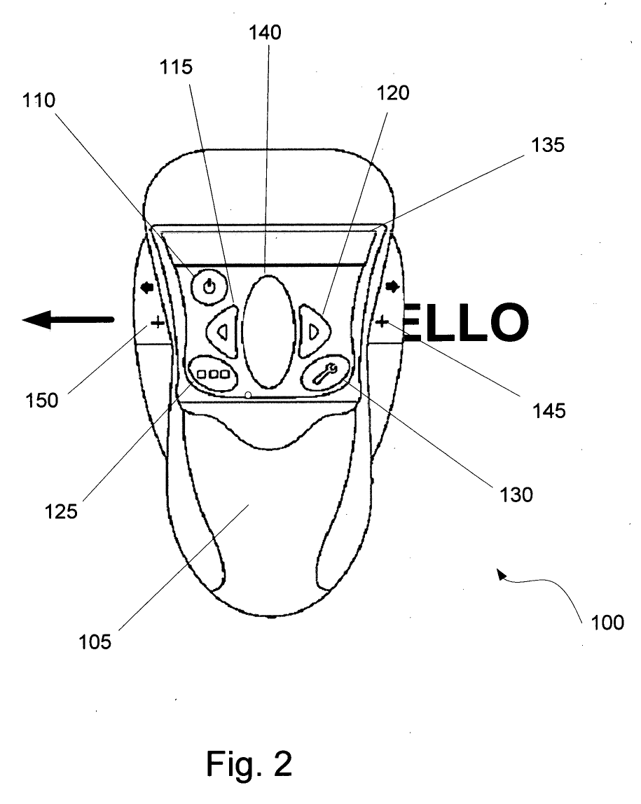

The hand-held printer 100 can include one or more guides to assist a user in printing. A right side guide 145 can assist users in printing in a left to right direction, as shown in FIG. 1. A left side guide 150 can assist users in printing in a right to left direction, as shown in FIG. 2.

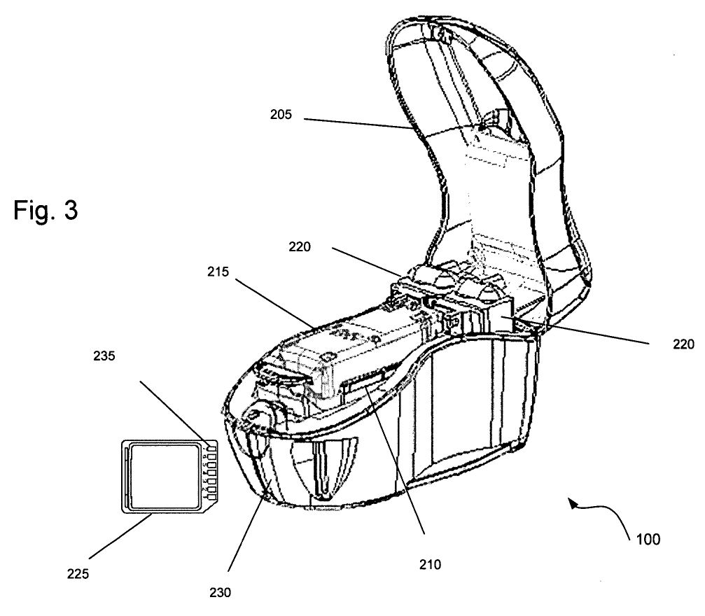

FIG. 3 illustrates the hand-held printer 100 with a first hinged cover 205 in an open position. The hand-held printer 100 can include a print cartridge 210 with a thermal printhead (not shown). The printhead can include two columns of print nozzles. In one embodiment, each column of print nozzles can include 320 individual nozzles aligned vertically. In some embodiments, the print nozzles can function in pairs, so that when a print nozzle in the first column prints, the print nozzle from the same row in the second column prints as well. This printing configuration can allow the printed image to appear nearly normal when a print nozzle in one column does not function properly (e.g., becomes clogged). The print cartridge 210 can be held in place by a second hinged cover 215. In one embodiment, the hand-held printer 100 can be powered by two 9 Vdc alkaline batteries 220.

In some embodiments, a memory card 225 can be inserted into a slot 230 in the front or another suitable portion of the hand-held printer 100. In one embodiment, the slot 230 can be accessed with the first hinged cover 205 closed, so that the memory card 225 to be exchanged for another memory card 225 without opening the hand-held printer 100. In some embodiments, the memory card 225 can be held in place by a biasing spring (not shown). The memory card 225 can be pressed into place. Pressing the memory card 225 again can release the memory card 225, so that the memory card 225 can be removed from the slot 230.

In one embodiment, the memory card 225 can have seven connectors 235 for transferring data to and from the memory card 225. When a memory card 225 is inserted into the slot 230 on the hand-held printer 100, the connectors 235 can mate with corresponding connections in the hand-held printer 100 and can enable the hand-held printer 100 to read the data stored on the memory card 225.

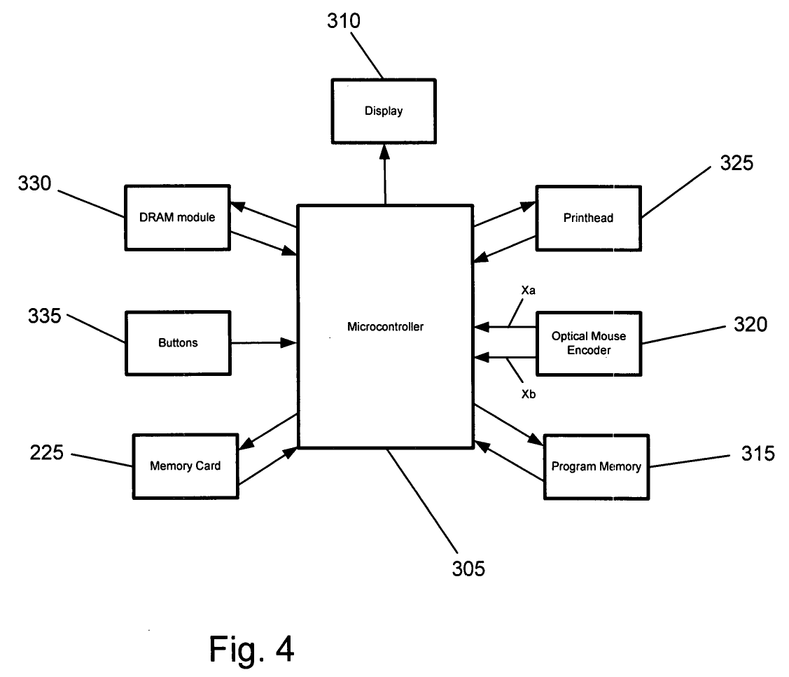

FIG. 4 illustrates one embodiment of architecture for the hand-held printer 100. The architecture of the hand-held printer 100 can include a microcontroller 305, a display 310, a program memory 315, an optical mouse encoder 320, a printhead 325, a dynamic random access memory (“DRAM”) module 330, buttons 335, and the memory card 225. As used herein and in the appended claims, the term “microcontroller” is not limited to just those integrated circuits referred to in the art as microcontrollers, but broadly refers to one or more microcomputers, processors, application-specific integrated circuits, or any other suitable programmable circuit or combination of circuits.

In one embodiment, the microcontroller 305 can be a low cost, low power application specific integrated circuit (“ASIC”). The display 310 can be a monochrome LCD display and can have a resolution of 101 pixels by 81 pixels. In one embodiment, the memory card 225 can be a 2-megabyte serial flash memory card (e.g., such as a model AT45DCB002 manufactured by Atmel).

The printhead 325 can perform the function of transferring ink from the hand-held printer 100 to the media being printed on. The printhead 325 can be a single color (e.g., black) or can contain multiple colors to print in full color. The printhead 325 can be a suitable printhead technology, such as ink-jet, laser, and dot matrix. In some embodiments, the printhead 325 can be a single color thermal ink-jet. The printhead 325 can include multiple print nozzles for depositing ink on the print media. The print nozzles can be in vertical alignment.

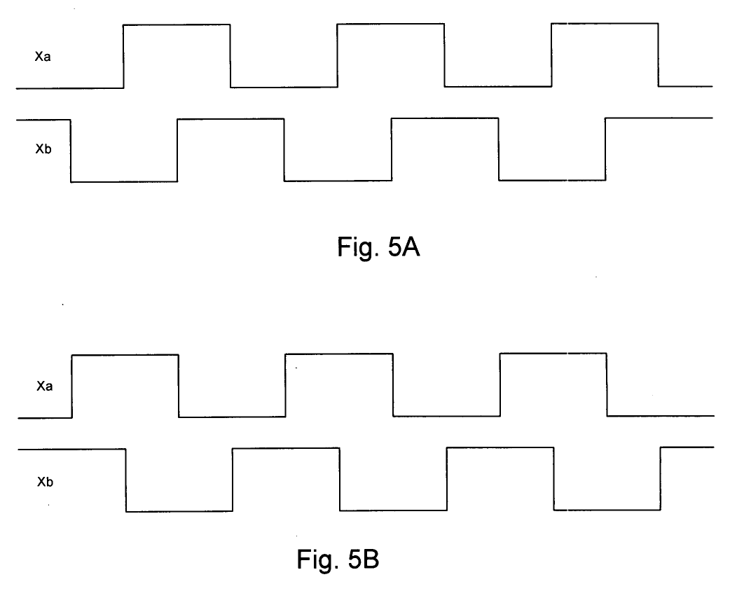

The optical mouse encoder 320 can include an optical mouse sensor (e.g., model ADNS-2051 manufactured by Agilent). The optical mouse encoder 320 can provide data to the microcontroller 305 via digital signals Xa and Xb (as shown in FIGS. 5A and 5B). Signals Xa and Xb can indicate a horizontal direction and a horizontal distance the hand-held printer 100 has moved. In one embodiment, the optical mouse encoded 320 can have a resolution of 400 counts per inch. Other embodiments can have other resolutions, such as 800 counts per inch. FIGS. 5A and 5B illustrate the relationship of the Xa and Xb signals to one another. When the optical mouse encoder 320 determines it has moved horizontally 1/400,″ either the Xa signal or the Xb signal can change from high-to-low or low-to-high. The order in which the signals change state can indicate the horizontal direction of movement. FIG. 5A illustrates an embodiment of the Xa and Xb signals as the mouse encoder 320 moves 12/400″ from left to right. Signal Xb can change from high to low to indicate 1/400″ of horizontal movement. The direction of movement can be determined to be left to right when Xa changes state (high-to-low or low-to-high) before Xb changes state. In FIG. 5A, both Xa and Xb change state six times, so that the total horizontal distance traveled can be 12/400″. FIG. 5B illustrates an embodiment of the Xa and Xb signals as the mouse encoder 320 moves right to left horizontally 12/400″. The direction of movement can be determined to be right to left when Xb changes state (high-to-low or low-to-high) before Xa changes state. In FIG. 5B, both Xa and Xb change state six times, so that the total horizontal distance traveled can be 12/400″. In some embodiments the mouse encoder 320 can be mechanical, rather than optical.

The memory card 225 can include data for printing icons. Data on the memory card can include a number indicating the number of icons stored on the memory card 225, a checksum, one or more distances to travel prior to printing, one or more bit-maps of thumbnail images, one or more print swaths, one or more pointers to the bit-maps, and one or more pointers to the print swaths.

A checksum can be used to determine the integrity of data stored in memory. The checksum can be implemented in byte, word, or multi-word formats. The checksum can include the entire memory or a portion of the memory. Other embodiments can use other methods of ensuring the integrity of the data on the memory card 225. These methods can include cyclic redundancy codes (“CRC”).

The bit-maps can be monochrome or color and can contain data for each pixel in an image. For monochrome bit-maps, the data can be a single bit. For color bit-maps the data can be any amount of data necessary to identify the color of each pixel.

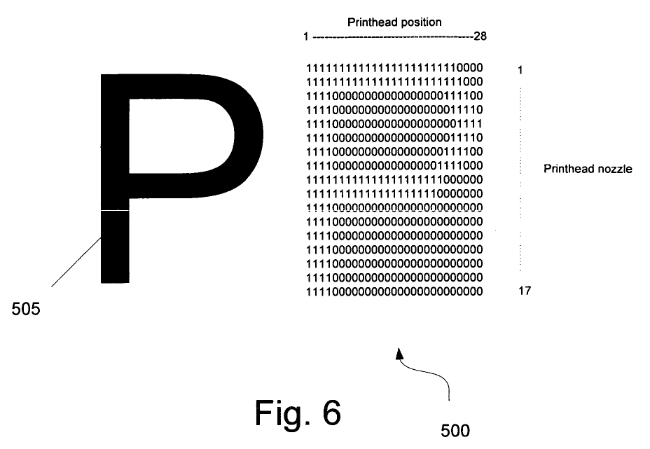

The print swaths can include data that instructs each print nozzle of the printhead 325 when to print. FIG. 6 illustrates a print swath 500 for printing the capital letter “P” 505 using a printhead 325 with seventeen print nozzles aligned vertically in a single column. As the “P” 505 is printed from left to right, the print swath 500 can direct each nozzle when to deposit ink and when to not deposit ink. As shown in FIG. 6, as the printhead 325 moves from left to right and from printhead position 1 to printhead position 28, the print swath 500 can start in its first column and all seventeen nozzles can deposit ink. As the printhead 325 moves to the right, all seventeen nozzles can deposit ink for the first four printhead positions. Once the printhead 325 reaches printhead position 5, nozzles 1, 2, 9, and 10 can deposit ink and the other nozzles do not deposit ink. Therefore, for each printhead position, the print swath 500 can include data for each print nozzle in order to inform the print nozzle whether to deposit ink on the media or not.

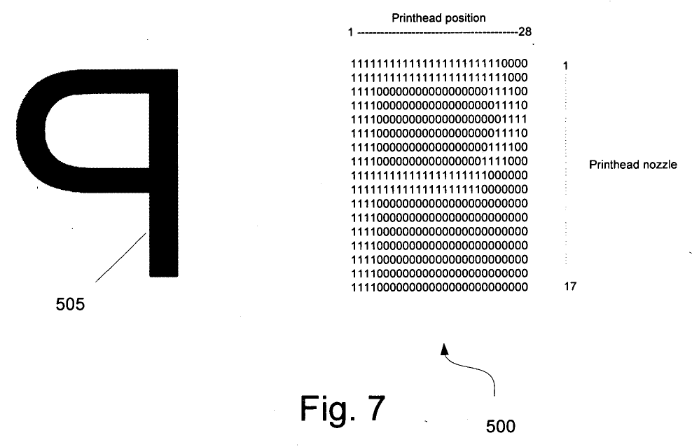

When the hand-held printer 100 moves in a right to left direction the printhead position 1 can be on the right of the printed icon. If the hand-held printer 100 did not compensate for this different direction of movement, the “P” 505 would print as shown in FIG. 7.

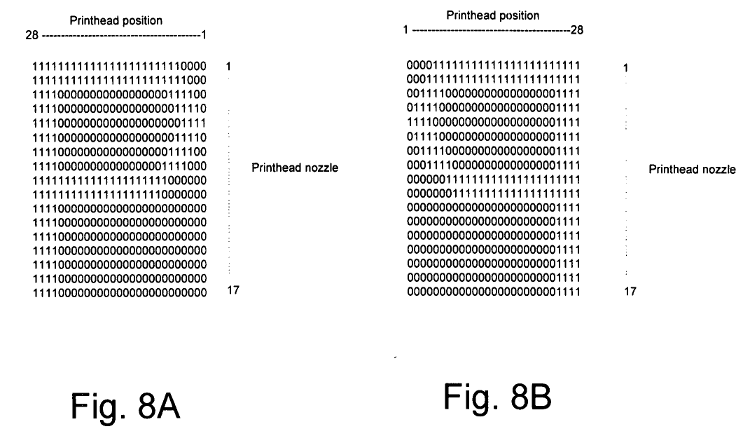

FIGS. 8A and 8B illustrate two embodiments of print swaths for printing in a right to left direction. In the first embodiment shown in FIG. 8A, the print swath 500 can be stored in memory as shown in FIG. 6. When printing in a right to left direction, the data can be sent to the printhead 325 starting at the end of the print swath 500 as indicated by printhead position 1, and continuing with each row until the start of the print swath 500 is reached, as indicated by printhead position 28.

In the second embodiment shown in FIG. 8B, the print swath 500 can be reversed in memory. The last row of the print swath can be moved into the position of the first row of the print swath. Next, the second to last row of the print swath can be moved into the position of the second row of the print swath. Moving the rows of the print swath can continue until the first row of the print swath 500 can be moved into the position of the last row of the print swath. In the second embodiment, the printing functions of the hand-held printer 100 can be the same for printing both in a left to right direction and in a right to left direction.

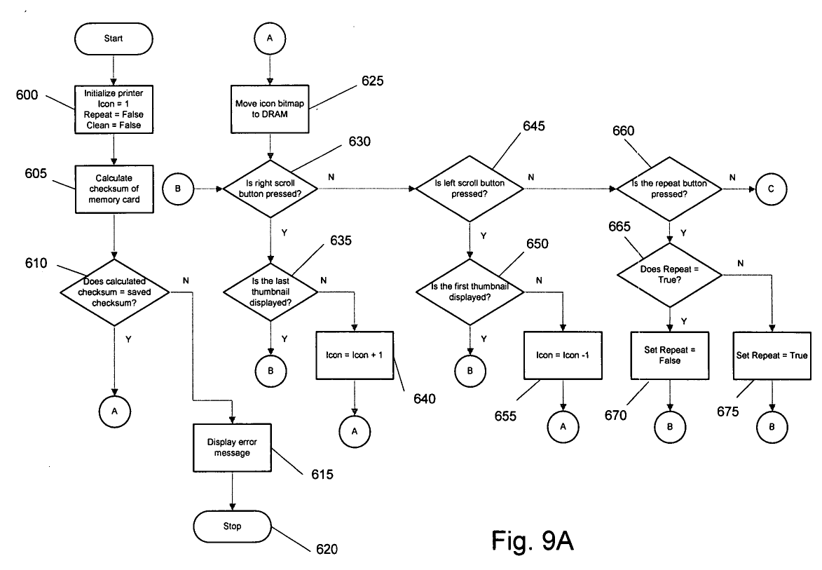

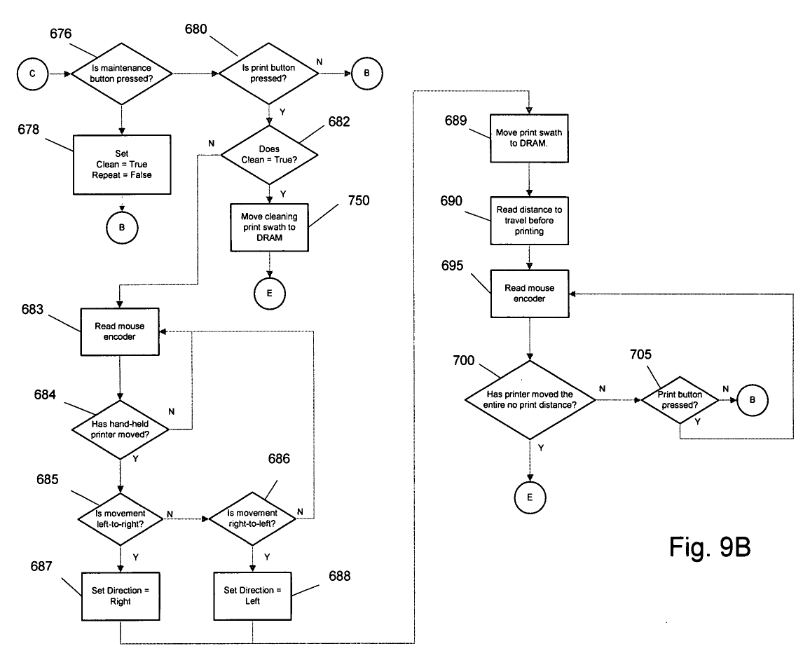

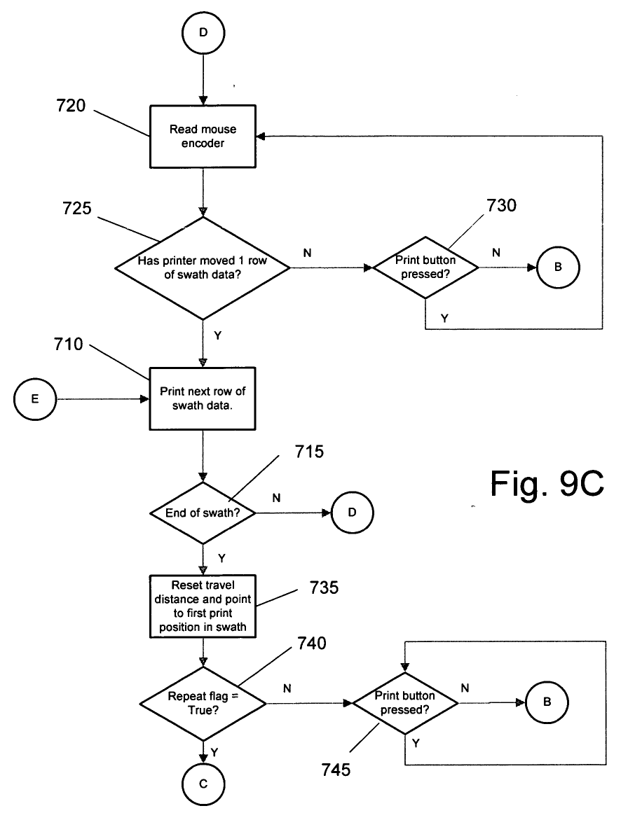

FIGS. 9A, 9B, and 9C illustrate an embodiment of the operation of the hand-held printer 100. When the hand-held printer 100 is powered on, the microcontroller 305 can initialize the system (step 600). During the initialization process, a counter indicating the icon to be printed can be set to “one” to indicate the first icon stored in the memory card 225. A flag indicating the status of a repeat mode can be set to “false” to indicate that the repeat mode is turned off. A flag indicating the status of a maintenance (clean) mode can be set to “false” to indicate that the clean mode is turned off.

The microcontroller 305 can read the memory of the data table and bit-maps stored on the memory card 225 and calculate the checksum of that memory (step 605). The microcontroller 305 can compare the calculated checksum to the checksum stored on the memory card (step 610). If the checksums do not match, the microcontroller 305 can display an error message on the display 310 and can stop operation (steps 615 and 620).

If the calculated checksum and the checksum stored on the memory card 225 match (step 610), processing can continue at step 625. The microcontroller 305 can read the offset to the first bit-map from the memory card 225 (step 625). The microcontroller 305 can read the bit-map data from the memory card 225 at that offset and transfer the bit-map data to a block of memory in the DRAM module 330. The microcontroller 305 can substantially continuously display the block of memory in the DRAM module 330 where the bit-map data is stored on the display 310.

The microcontroller 305 can determine whether the right scroll button 120 is pressed (step 630). If the right scroll button 120 is pressed, the microcontroller 305 can determine whether the icon number is equal to the number of icons stored on the memory card (step 635). If the icon number is equal to the number of icons stored on the memory card, the microcontroller 305 can continue processing (step 630). If the icon number is less than the number of icons stored on the memory card, the microcontroller 305 can increase the icon number by one (step 640) and processing can continue (step 625) where the bit-map for the new icon can be moved to the DRAM module 330 and can be displayed on the display 310.

If the right scroll button 120 was not pressed (step 630), the microcontroller 305 can determine whether the left scroll button 115 is pressed (step 645). If the left scroll button 115 is pressed, the microcontroller 305 can determine whether the icon number is equal to one (step 650). If the icon number is equal to one, the microcontroller 305 can continue processing (step 630). If the icon number is greater than one, the microcontroller 305 can decrease the icon number by one (step 655) and processing can continue at step 625 where the bit-map for the new icon can be moved to the DRAM module 330 and can displayed on the display 310.

If the left scroll button 115 was not pressed (step 645), the microcontroller 305 can determine whether the repeat button 125 is pressed (step 660). If the repeat button 125 is pressed, the microcontroller 305 can determine whether the repeat flag is true (step 665). If the repeat flag is true, the microcontroller 305 can set the repeat flag to false (step 670). If the repeat flag is not true, the microcontroller 305 can set the repeat flag to true (step 675). After the repeat flag is set, the microcontroller 305 can continue processing (step 630).

If the repeat button 125 was not pressed (step 660), the microcontroller 305 can determine whether the maintenance button 130 is pressed (step 676 of FIG. 9B). If the maintenance button 130 is pressed, the microcontroller 305 can set the clean flag to true and the repeat flag to false (step 678). Processing can then continue (step 630).

If the maintenance button 130 was not pressed (step 676), the microcontroller 305 can determine whether the print button 135 is pressed (step 680). If the print button 135 is not pressed, the microcontroller 305 can continue processing (step 630). If the print button 135 is pressed, the microcontroller 305 can determine whether the clean flag is set to true (step 682). If the microcontroller 305 determines that the clean flag is not set to true the microcontroller 305 can check the data from the optical mouse encoder 320 to determine if the hand-held printer 100 has moved horizontally (steps 683 and 684). If the microcontroller 305 determines that the hand-held printer 100 has not moved, the microcontroller 305 can continue checking the data from the optical mouse encoder 320 until the hand-held printer 100 has moved horizontally (steps 683 and 684). Once the microcontroller 305 determines that the hand-held printer 100 has moved in a horizontal direction, the microcontroller 305 can determine whether the direction of movement was from left to right (step 685) or from right to left (step 686). The microcontroller 305 can set a direction flag to “Right” if the direction of movement was left to right or “Left” if the direction of movement was right to left (steps 687 and 688).

The microcontroller 305 can retrieve the offset to the print swath stored in the memory card 225 for the icon selected. The microcontroller 305 can move the print swath data from the memory card 225 to a block of memory in the DRAM module 330 reserved for the print swath data (step 689). In some embodiments, the microcontroller 305 can determine the direction of movement and if the movement is right to left, the microcontroller 305 can reverse the print swath data in memory, as shown in FIG. 8B. The length of the data to be moved can be equal to the offset of the bit-map for the next icon minus the offset of the print swath for the selected icon. The microcontroller 305 can read from the memory card 225 the distance that the hand-held printer 100 can travel before beginning to print for the selected icon (step 690).

The microcontroller 305 can analyze the data from the optical mouse encoder 320 to determine if the hand-held printer 100 has traveled a distance step 695. The microcontroller 305 can determine whether the distance traveled equals the distance the hand-held printer 100 should travel before beginning to print for the selected icon (step 700). If the hand-held printer 100 has not traveled the distance required before printing for the selected icon, the microcontroller 305 can determine whether the print button 135 is still pressed (step 705). If the print button 135 is still pressed, the microcontroller 305 can continue processing (step 695) with reading the optical mouse encoder 320. If the print button 135 is no longer pressed, printing can stop and the microcontroller 305 can continue processing (step 630).

If the microcontroller 305 determines that the hand-held printer 100 has moved the distance necessary before printing can begin for the selected icon (step 700), the microcontroller 305 can send a row of data from the print swath to the printhead 325 causing the printhead 325 to print the data (step 710 of FIG. 9C). In some embodiments, if the direction of movement is right to left, the microcontroller 305 can start at the last row of data in the print swath and can successively print the preceding rows of data in the print swath, as shown in FIG. 8A.

The microcontroller 305 can then determine whether the entire print swath has been printed (step 715). If the microcontroller 305 can determine that the end (or the beginning for some embodiments when printing right to left) of the print swath has not been reached, processing continues (step 720) where the microcontroller 305 can read the optical mouse encoder 320. The microcontroller 305 can determine whether the hand-held printer 100 has moved a distance such that the next row of data from the print swath should be sent to the printhead 325 step 725. If the microcontroller 305 determines that the distance moved is not sufficient to send the next row of data from the print swath to the printhead 325, the microcontroller 305 can determine (step 730) whether the print button 135 is still pressed. If the microcontroller 305 determines that the print button 135 is still pressed, processing can continue with reading the optical mouse encoder 320 (step 720). If the microcontroller 305 determines that the print button 135 is no longer pressed (step 730), printing can stop and the microcontroller 305 can continue processing (step 630).

If the microcontroller 305 determines that the hand-held printer 100 has moved a sufficient distance (step 725), the microcontroller 305 can continue processing by sending the next row of data from the print swath (or the previous row of data from the print swath in some embodiments when printing in a right to left direction) to the printhead 325 (step 710).

If the microcontroller 305 determines that the entire print swath has been sent to the printhead 325 (step 715), the microcontroller 305 can reset the distance traveled before printing to zero and can point to the start of the print swath (or to the end of the print swath in some embodiments when printing in a right to left direction) (step 735) The microcontroller 305 can determine whether the repeat flag is set to true (step 740). If the microcontroller 305 determines that the repeat flag is set to true, processing can continue (step 680) and the process of printing the icon can be repeated. If the microcontroller 305 determines the repeat flag is set to false, the print job is complete and the microcontroller 305 can determine whether the print button 135 is still pressed (step 745). If the print button 135 is still pressed, the microcontroller 305 can loop back (step 745) until the print button 135 is no longer pressed. The microcontroller 305 can then continue processing (step 630).

If the microcontroller 305 determines that the clean flag is set to true (step 682), the microcontroller 305 can move a cleaning print swath to the block of memory in the DRAM module 330 reserved for the print swath data (step 750). In some embodiments, the cleaning print swath can be an icon ½″ by 12″ in which every print nozzle prints at every printhead position. The cleaning print swath can clean each of the print nozzles and improve print quality. Once the cleaning print swath has been moved to the DRAM module 330, processing can continue with printing of the print swath (step 710).

Thus, embodiments of the invention provide, among other things, a hand-held printer capable of printing in a left to right direction or a right to left direction. Various features and advantages of the invention are set forth in the following claims.

1. A method of printing with a hand-held printer, the method comprising:
detecting a direction of initial movement of the hand-held printer;
establishing a mode of operation including one of a left-justified mode when the direction of initial movement is left to right and a right-justified mode when the direction of initial movement is right to left; and
maintaining the mode of operation for substantially an entire print job.

2. The method of claim 1 and further comprising:
printing a print swath having a beginning and an end; and
printing the print swath from the beginning to the end when the mode of operation is left-justified.

3. The method of claim 1 and further comprising:
printing a print swath having a beginning and an end; and
printing the print swath from the end to the beginning when the mode of operation is right-justified.

4. The method of claim 1 and further comprising reversing a print swath in a memory when the mode of operation is right-justified.

5. The method of claim 1 and further comprising repeating printing of a print swath when a repeat function is selected.

6. The method of claim 1 and further comprising traveling a predetermined distance before printing.

7. The method of claim 1 and further comprising displaying an image of a print swath to be printed.

8. A method of printing a right-justified image, the method comprising:
detecting a right to left direction of movement;
pointing to a last row of data in a print swath;
printing the last row of data;
pointing to a preceding row of data in the print swath; and
printing the preceding row of data.

9. The method of claim 8 and further comprising repeating printing of the print swath when a repeat function is selected.

10. The method of claim 8 and further comprising traveling a predetermined distance before printing.

11. The method of claim 8 and further comprising printing text from a language that is read right to left.

12. The method of claim 8 and further comprising displaying an image of a print swath to be printed.

13. A hand-held printing system, the system comprising:
a memory;
a printhead connected to the memory; and
a microcontroller connected to the memory and the printhead, the microcontroller determining a horizontal direction of movement and at least one of reversing a print swath in the memory and printing a print swath in reverse order when the horizontal direction of movement is determined to be a right to left direction.

14. The system of claim 13 wherein the microcontroller delays printing until the hand-held printer has traveled a predetermined distance.

15. The system of claim 13 wherein the microcontroller repeats printing when a repeat function is selected.

16. The system of claim 13 wherein the memory includes at least one of dynamic random access memory and a memory card.

17. The system of claim 13 and further comprising an optical mouse encoder that detects the direction of movement and a distance of movement and provides the microcontroller with a set of signals.

18. The system of claim 13 and further comprising a liquid crystal display.
